(19) United States
(12) Patent Application Publication
(10) Pub. No.: US 2017/0245112 A1
(43) Pub. Date: Aug. 24, 2017

(54) MULTIMEDIA LOCATION TRENDS MANAGEMENT

(71) Applicant: FIRDAUS MAH MAH LOK, SHAH ALAM (MY)

(72) Inventor: FIRDAUS MAH MAH LOK, SHAH ALAM (MY)

(21) Appl. No.: 15/523,381

(22) PCT Filed: Oct. 16, 2015
(86) PCT No.: PCT/MY2015/050132

§ 371 Date: Apr. 29, 2017

(30) Foreign Application Priority Data
Nov. 3, 2014 (MY) PI 2014703237

(51) Int. Cl. H04W 4/02; H04L 12/58; G06Q 50/00

(52) U.S. Cl. CPC H04W 4/023; G06Q 50/01; H04W 4/026; H04L 51/32; H04M 2250/10

(57) ABSTRACT

A computer implemented method for the management of multimedia contents based on the location trends of a system is disclosed. In one of the embodiment, an adaptive method is used to query, display, organize, interact and rate the multimedia contents based on the target location criteria with the purpose of providing a location trending presentation. A suggestive method is used to provide links to the language learning system and booking suggestion associated to the location of the multimedia content.

### FIELD OF THE INVENTION

This invention relates to a method for a mobile device to manage multimedia content such as photos/images/videos/documents that are queried based on the location trend criteria from a web service data store by using location information that can be taken from a location system such as from a GPS module. The invention more particularly relates to the method of which the multimedia contents are displayed, organized, interacted and rated for/by the user of the mobile device.

### BACKGROUND OF THE INVENTION

It is common nowadays that people travel all over the world with a smart phone. And one of the very popular activities for these travellers is sharing photos or any kind of multimedia content through social network using smartphone apps. The smartphone device can also have location capabilities to provide the user with its current location that can be used for various enhanced services.

For the travellers, there is an interest in the photos that is shared at the given location and also photos of the areas surrounding it. As social network is a lot to do with trends, contextual information of the multimedia content such as latest, highly rated, popular and others would be of very high interest.

There are many ways that has been done to present these multimedia contents based on location for the users. Some apps have displayed just a collection of photos in a set area or radius of the location without providing a more user centric adaptive approach in querying and organizing the layout of these photos. Besides that, ratings are very simplified and targeted on to the specific location. In the other hand, there has been many ways of multimedia content interactions but there are none that overlays with interactive contextual content that can share to the social media with the dynamic animations of these composite multimedia content and contextual information. And also, not having the suggestive systems that may help in relation to the target location.

### SUMMARY OF THE INVENTION

The invention aims to provide a useful alternative method for travellers to view the trends that are adaptive to the traveller's target location criteria by using multimedia contents such as photos or videos or documents, multimedia content display and interaction, cascading location rating system and a suggestive booking and/or map navigation system and/or language learning system that is related to the multimedia content location.

The multimedia content location trends feed layout are divided into sections. These sections are divided into 3 windows. The order of the sections is that the top most section is the current user target location followed by the next progressive expanded larger area or radius which an iterative process and beyond. So for example, it could be the first section is KLCC, followed by KL City, Kuala Lumpur, Malaysia, South East Asia, Asia and the rest of the world. The 3 windows are used to determine the weightage to the multimedia content distribution. The first window has a reducing formula for weightage, the second window has an increasing formula for weightage and third window has no weightage and can display unlimited multimedia content depending on the query criteria. The reducing and increasing weightage formula can be in an exponential formulation or a linear formulation. The second window has a stronger weightage factor for the increasing formula than the first window for the reducing formula. For example, the second window first section can have the total amount of the first section of the first window. The total initial allocated trends to be queried can be a defined amount or the total of the target location multimedia contents to be displayed or can be based on amount that can be displayed on the current initial display area for the trend window.

For multimedia content location trends feed stated, the multimedia contents are displayed in smaller resized form that are queried from the data store of the shared multimedia contents based on the target location criteria.

The request for more trends after the initial multimedia location trends load; such as the action of scrolling in the direction for more, the queries for more trends can be for the last expanded larger area or radius of the target location criteria or larger.

In the situation where by for each section of the location criteria query yields less result than the allocated weightage amount, the residual weightage amount will be carried forward to the next section. The continuation of carrying forward the residue in the case of insufficient data will give the impression that priority is given to multimedia contents that are closer to the target location.

The “criteria” as mentioned many times in the phrase “location criteria” can be understood as in any kind of context in relation to the multimedia content such as latest postings, most popular rated, most popular liked, most popular visited, oldest postings, most commented, most shared, time information, weather information, based on certain tags that are defined in the implementation or based on data analytics of the target location.

The invention also states that the layout of the multimedia contents trend should be organized in close proximity with each other. It can be in a resized or manipulated form of the original multimedia content in a sequential order such as left to right and after reaching the maximum number of displays for the row will continue on the following row which is directly below of the current row; or top to down and after reaching the maximum number of displays for the column will continue on the following column which is directly right of the current row. This layout may be also done in vice versa order; instead of top it is bottom, instead of right it is left; of the mentioned steps.

By selecting the multimedia contents from the multimedia location trends feed, it can navigate to a multimedia content detail window that contains original or superimpose or enlarge multimedia content and provide variety of contextual information attached to the multimedia content. The multimedia content will have an overlay that contains the contextual information. Location is a contextual information that is mandatory to display and can be navigable to a window consisting a collection of multimedia contents of the particular location. This window for the location will generate suggestion for bookings and/or map navigation system and/or language system associated to the particular location.

This multimedia content detail window contextual information may contain rating information. This rating is the average rating for the location of the multimedia content. Whenever a user sets a rating for the location in the multimedia content, a cascading rating system will take effect whereby the rating scores will be added up to the next progressive larger area or radius of the location and calculated the rating average. This cascading action adding and averaging calculation will iterate until the last larger area or radius of the multimedia content location.

### BRIEF DESCRIPTION OF THE DRAWINGS

In order that the invention can be more readily understood and put into practical effect, a preferred example of the invention will now be described with reference to the accompanying drawings, in which:

FIG. 1 illustrates a preferred example of the user interface for capturing multimedia content, and providing contextual information such as location, date, time and weather information. On the right navigational panel are the user multimedia contents at the top and the trending multimedia contents 12 at the bottom. The management and layout formulation of trending multimedia contents 12 is the focus of the invention methods.

FIG. 2 illustrates a preferred example of the user interface for multimedia content location trends. The organization of the number of multimedia contents displayed is formulated by the weightage curve 17 to give it a more location criteria centric preference.

FIG. 3 illustrates a preferred example of the user interface for the multimedia content detail window used for providing variety of additional contextual information for the multimedia content that includes location, weather information, timestamp, ratings and review comments. An overlay 34 that is a separate view on top of the multimedia content containing these contextual information. This overlay is in a maximized view 34 which can be triggered to be minimized. A share trigger 33 is used to share composite multimedia content with animated weather icon and contextual information that is overlaid on the multimedia content.

FIG. 4 illustrates a similar preferred example of the user interface for the multimedia content detail window to FIG. 3. Difference for FIG. 3 to FIG. 4 is the overlay that is in a minimized view 39 which can be triggered to be maximized. The contextual information text is summarized and reduced in size; and the weather animated icon is also reduced in sized; on a single line in the overlay.

FIG. 5 illustrates a window consisting of a collection of multimedia contents 44 of a particular selected location 45 that was navigated from the location trigger of the multimedia content in FIG. 3 or FIG. 4. In FIG. 5 consist of the booking suggestion and/or map navigation system and/or language suggestion associated to the selected location.

FIG. 6 illustrates an example implementing the rating cascading method for the location whereby 50 table is the original rating values and 52 table is the calculation of the rating values after +2 ratings is added to the example location KLCC. In these two tables in 50 and 52, the top most is the target location and the subsequent rows at the bottom are areas or regions that is larger than the previous row location.

The “photo” mentioned is a type of multimedia content and can be broadly referred as multimedia content in relation to this invention.

### DETAILED DESCRIPTION

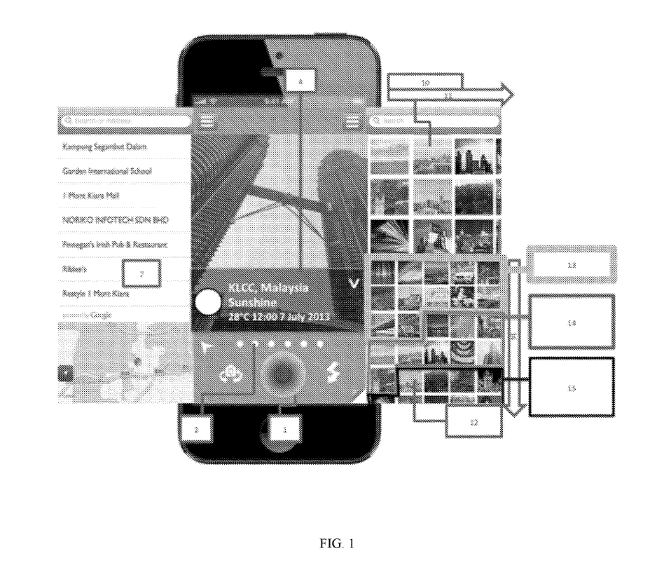

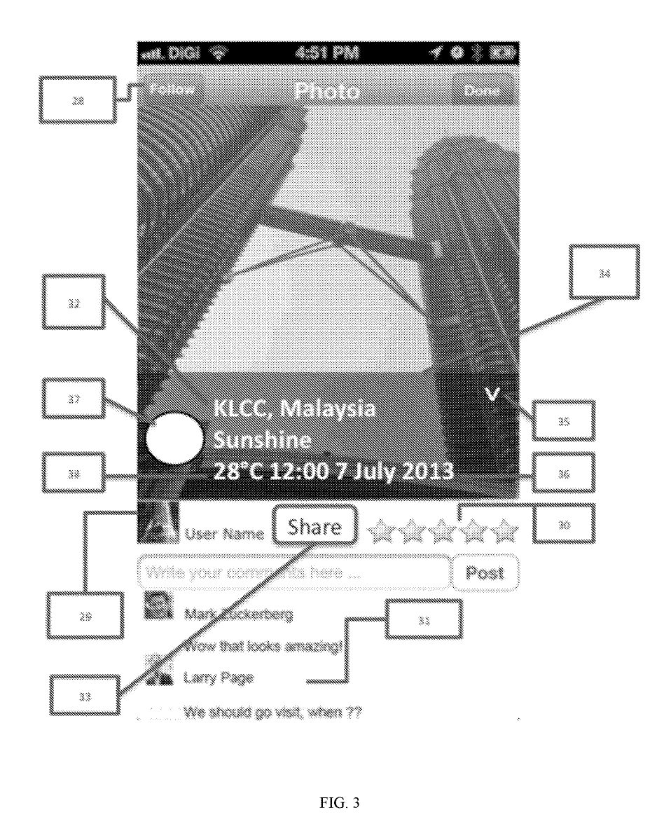

Referring to FIG. 1, to initially capture and share a multimedia content, the user of the mobile app will capture 1 a multimedia content of the location; the mobile app will then obtain information of the current date and time and weather 4 which is overlaid according to the user preferred style 2; the mobile app will then provide suggestion of potential current location 7 for the user to select. The user then shares 1 the multimedia content to the rest of the world on that particular location; whereby multimedia contents that are shared are stored in a data store. The multimedia contents that are captured and shared by the user appears in user feeds section 10 that can be scrolled to the right 11 for more. By selecting the multimedia content, the mobile app will navigate to the multimedia content detail as shown in the example on FIG. 3.

The area of trending feeds 12 is an area of focus for the invention method. The trending feeds 12 is divided into multiple section though not noticeable by user. In the example shown in FIG. 1, 13 is the user target location trend. This 13 would be the multimedia contents shown in the current user target location or close to the current user target location; whereby is the first section of the trends. The next section 14 is the next progressive location expanded larger area or radius area criteria which could be the city area multimedia contents. And the following section 15 is the next progressive expanded larger area or radius location criteria which could be the state area multimedia contents. By scrolling for more 16, the queries would be the continuation of the last location expanded larger area or radius criteria, which in this case could be the country, continent, and beyond.

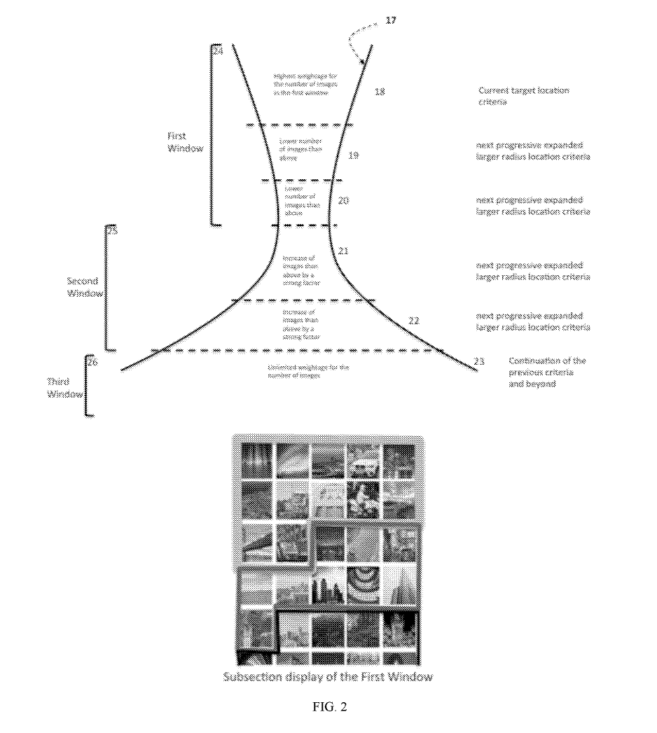

Referring to FIG. 2, an exemplary trending multimedia contents distribution weightage curve 17 as following the definition in the claims. The distribution weightage formula is divided into 3 windows. The 24 First Window starting at the very top is using reducing weightage formula for each subsequent section of the trending distribution. In 18, which is the top first section of 24 First Window, displays the current target location criteria; it can display with the highest weightage for the total initial allocated trending multimedia contents to be displayed in 24 First Window. The following section 19 below, is the next progressive expanded larger area or radius location criteria, which could for example be the city of the target location. Section 19 can have a reduced weightage for the total initial allocated trending multimedia contents than section 18. This reducing weightage formula continues progressively with possibly more sections until 20 last section of 24 First Window.

The next window is 25 Second Window which uses the increasing weightage formula for each subsequent sections of the trending distribution. The 25 Second Window increasing formula has a stronger factor for increase than the reducing formula in the 24 First Window. The 21 first section of 25 Second Window will start with a strong factor with the total amount of allocated trending multimedia contents of the First Window. Section 21 is typically set to be the country of the current target location. Section 22 is the next progressive expanded larger area or radius of the location criteria. An example would be if section 21 is country, then section 22 is the region or continent. Then if Malaysia is the country, the region would be South East Asia. A stronger factor is used in section 22 and will have an increased amount than the previous section 21 for the number of multimedia contents displayed. The progressive increasing formula is used for every subsequent section in the 25 Second Window. The last window is the 26 Third Window. There is no weightage for the number of multimedia contents to be displayed and it is unlimited. This 26 Third Window will display trending multimedia contents for the rest of the world 23. The whole layout and organization of the multimedia contents as depicted in FIG. 2 is supposed to provide an adaptive approach in querying trending multimedia contents that is prioritized initially towards the current target location of the user and then to the larger extend of the world trend. The multimedia contents in the explanation can be used in any other multimedia content for displaying trends.

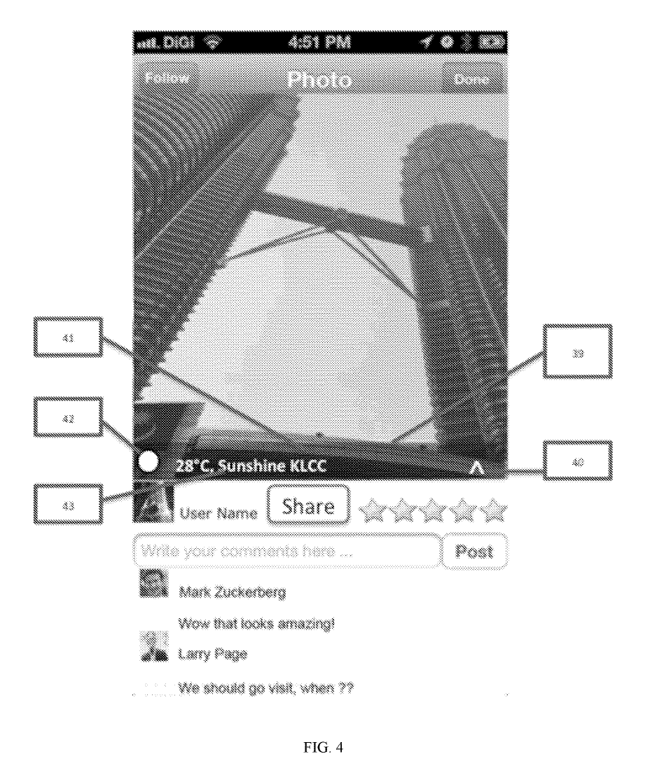

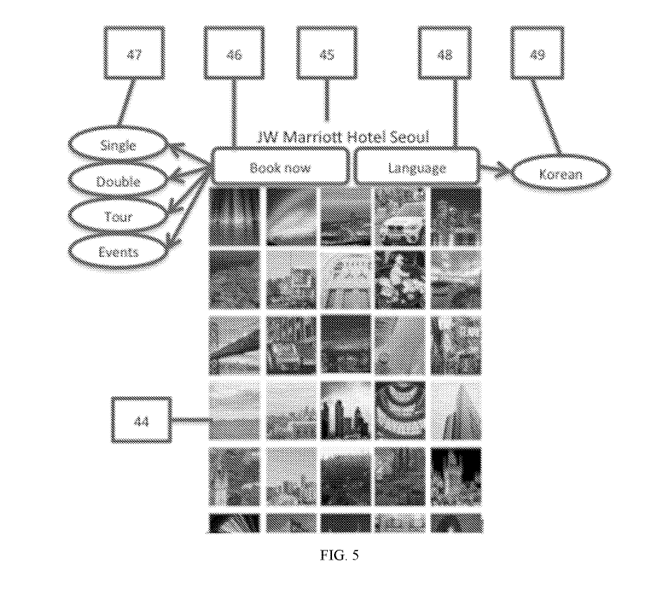

Referring to FIG. 3, is the user interface example for the multimedia content detail window used for displaying additional contextual information for the shared multimedia content such as 29 user profile image link of the sharer, 28 button to follow the selected multimedia content, 30 selection and average ratings of the multimedia content and 31 reviews made to the multimedia content in the social network. The multimedia content that is displayed contains an overlay 34 on top of the multimedia content. This overlay is a separate view that contains a graphical background layer with a set transparency used to highlight other contextual information and animated icon for the multimedia content condition is displayed on the overlay. The contextual information and icon displayed includes location 32, weather animated icon 37, weather information 38 and/or timestamp 36. The location 32 information in the overlay is mandatory and navigable to a window as illustrated in FIG. 5 displaying a collection of multimedia content 44 of the particular location. The overlay 34 can have a maximized or minimized view. In the example in FIG. 3, the overlay 34 is in a maximized view. A minimize trigger 35 in a maximized overlay is used to minimize the overlay as shown in 39 of FIG. 4. FIG. 4 which is the alternate for FIG. 5, whereby the overlay is a separate view on top of the multimedia content that contains a graphical background layer with a set transparency used to highlight contextual information and icon for the multimedia content condition are minimized 39. This minimized overlay has a single line of icon and text containing the multimedia content contextual information. The size of the weather animated icon 42, text containing weather information 43 and location 41 are reduced as compared to the maximized overlay 34 in FIG. 3. A maximized trigger 40 exists in the minimized overlay 39 to trigger the overlay to be maximized as in 34 in FIG. 3. The share trigger 33 in FIG. 3 and FIG. 4 is to share an animated media format such as animated gif or video of the composite multimedia content and the stated maximized overlay 34 that consists of contextual information and animated weather icon without the overlay background graphics. The share of the animated media format can be the media file or a link to the media file that is posted in the social network, send via a messaging platform or saving it to the local or network system.

FIG. 5 is this window consisting of a collection of multimedia contents 44 of the particular location 45 which is navigated into by location selection from the multimedia content such as illustrated in the example of FIG. 3 and FIG. 4. The system can generate a suggestive trigger for booking 46 and/or language 48 associated to the particular location 45. The booking trigger 46 generates products, services and/or amenities associated to the particular location 47. Selecting the options for the booking can be processed by a payment gateway system. The language trigger 48 generates associated language of the particular location and providing a link navigable to the language learning system 49 of the suggested language.

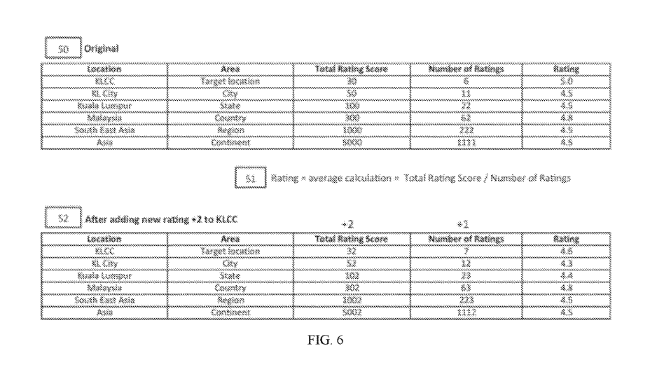

The selection and average ratings 30 of the multimedia content; whereby the rating selection score set by the user is added to the location rating of the multimedia content and the score is cascaded further to the larger region of the location. In FIG. 6 is an illustration of an example whereby Kuala Lumpur Twin Tower (KLCC) is rated by the user from a multimedia content that is currently viewed. 50 is a table showing the original rating scores of KLCC and the enlarged area location of KLCC. 50 table shows that the current rating value is 5.0 for KLCC. Table 50 and 52 also contains all the expanded larger area or radius for KLCC location. 51 is the formula for the rating where by it is the average calculation the total rating score divided by the number of ratings. In 52, after a user has added a new rating score of 2, KLCC rating score is now 32 which then makes the new rating average to be 4.6. In 52 also, it is illustrated, the user rating score of 2 is then cascaded to add to the total rating score of the next larger area or radius which in this example would be KL City, Kuala Lumpur, Malaysia and beyond. This cascading effect will then have a new rating average for all the cascaded location areas that are affected.

1. A computer implemented method for the management of multimedia contents based on the trends of the location criteria consists of:
a. the multimedia contents which are multimedia contents or videos or documents;
b. the management of the multimedia contents purpose is to manage the display layout and interactivity of the multimedia content trends in the window;
c. the trends are queries from the data store of the multimedia contents that are tagged with location centric contextual information;
d. the queries of the trends are ordered by sections; begins from the target location criteria and progressively expanded to the larger area or radius of the target location criteria;
e. these ordered sections are grouped into 3 windows that has determined weightage formulation for the distribution of the multimedia content trends; the initial first window uses a reducing weightage formula for determining the allocated number of multimedia content to be displayed for each subsequent section in that particular window; the next second window uses an increasing weightage formula for determining the allocated number of multimedia content to be displayed for each subsequent section in that particular window; and last third window that has unlimited allocation for the number of multimedia content to be displayed for the final and only section. The reducing and increasing weightage algorithm in these windows can be in an exponential formulation or a linear formulation.

2. The computer implemented method of claim 1, the target location information is provided by the location module of the mobile device or connected to the mobile device such as a GPS module or the location can be given by the user of the system.

3. The computer implemented method of claim 1, whereby the sections in the first window starts from target location criteria and continues progressively with sections of the larger area or radius before country; sections in the second window starts from country and continues progressively with sections of the larger area before the rest of the world; third window will consist of the trends of the rest of the world.

4. The computer implemented method of claim 1, whereby if for each location trend query yields less result than the allocated weightage amount, the residual amount can be carried forward to the next progressive step query of the expanded larger radius of the target location criteria.

5. The computer implemented method of claim 1, the second window has a stronger weightage factor than the first window; the first window will have an allocated content amount whereby the first section of the second will use the same allocated amount and the subsequent section in the second window will use an increasing weightage formulation on the content allocation based on the allocation of the first section of the first window.

6. The computer implemented method of claim 1, the window can be a scrollable window; which can consists of the current initial display area for the window that can be scrollable for more display area; the initial multimedia location trend load is for loading multimedia contents in the initial load area set for the total initial allocated trends in the scrollable window and the request for more trends is the action of scrolling in the direction for more or the action of key press that is identified as to request for more trends.

7. The computer implemented method of claim 1, the criteria of the trend queries can be based on latest postings and/or most popular rated and/or most popular liked and/or most popular visited and/or oldest postings and/or most commented and/or most shared and/or time information and/or weather information and/or based on certain tags that are defined in the implementation and/or based on data analytics of the target location and/or based on a rolling period.

8. The computer implemented method of claim 1, the layout of the multimedia contents location trend in the window is organized in close proximity with each other; can be in a resized or manipulated form of the original multimedia content in a sequential order such as left to right and after reaching the maximum number of displays for the row can continue on the following row which is directly below of the current row; or top to down and after reaching the maximum number of displays for the column can continue on the following column which is directly right of the current row; or the layout can be also done in vice versa order; instead of top it is bottom, instead of right it is left; of the mentioned steps.

9. The computer implemented method of claim 1, the multimedia content detail window is a window that has the original multimedia content or superimpose or enlarge multimedia content as compared to the size of the multimedia content displayed in the trend; whereby this window provides variety of contextual information attached to the multimedia content; these contextual information consists of location and timestamp and/or rating and/or description; that can be navigated to this window by selecting the multimedia contents from the trends feed of claim 1.

10. The computer implemented method of claim 9 but not necessary consisting of claim 1, where by rating is a contextual information attached to the multimedia content location; whereby rating is the total rating score divided by the number of rating inputs for the location of the particular multimedia content; rating score can be given as a user input to be added to the total rating score for the location of the particular multimedia content and this rating score can have cascading effect to add to the total rating score of the larger region of the defined location.

11. The computer implemented method of claim 9 but not necessary consisting of claim 1 and/or claim 10, upon user selecting the location contextual information of the particular multimedia content will be able to navigate to a window that consists of a collection of multimedia content of that particular location and generates the following:
a. booking suggestions of the location; whereby the booking suggestion can be for the products, services and/or amenities associated to the location; the booking may consist integration into a payment system that can process the payment of the booking.
b. and/or by using location language suggestion system; the system can suggest links to a language learning system that is useful and related to the content location; whereby the location language suggestion system can be a mapping of locations to an ordered list of most useful languages for the particular location; with the language.
c. and/or map navigation system; the system can provide navigational direction with map to the target destination location from the current location.

12. The computer implemented method of claim 9 but not necessary consisting of claim 1, the multimedia content in the multimedia content detail as in claim 9 is overlaid with contextual information and animated condition icon of the multimedia content; whereby the overlay is a separate view on top of the multimedia content; whereby the overlay style is chosen by the user during the multimedia content submission into the system; whereby the contextual information of the location is acquired from a location system based on the longitude and latitude of the multimedia content, weather is acquired from weather system based on the longitude and latitude of the multimedia content location and timestamp and animated condition icon based on user input and/or weather condition acquired from the weather system based on the longitude and latitude of the multimedia content location and timestamp; whereby the overlay has a graphical background layer with a set transparency to highlight the contextual information text and animated condition icon that is associated to the multimedia content; whereby the animated condition icon can be animated weather icon and/or current condition of the multimedia content; whereby the contextual information in the overlay contains location, weather information and/or timestamp; whereby the location is a mandatory text to appear in the contextual information in the overlay; whereby the overlay can be minimized in a maximized view by a minimize trigger in the overlay or maximized in a minimized view by a maximize trigger in the overlay; a share trigger in the multimedia content detail is used to share a composite multimedia content and the stated maximized overlay that consists of contextual information and animated condition icons without the overlay background graphic in an animated media format such as animated gif or video by file or a link to the media file that is posted in the social network, send via a messaging platform or saving it to the local or network system.
